(19) United States
(12) Patent Application Publication
(10) Pub. No.: US 2013/0287987 A1
(43) Pub. Date: Oct. 31, 2013

(54) Protective film for applying to a display and set for applying a protective film to a display

(71) Applicant: Tormaxx GmbH, (US)

(72) Inventor: Hubert KOCH, Moenchengladbach (DE)

(21) Appl. No.: 13/862,637

(22) Filed: Apr. 15, 2013

(30) Foreign Application Priority Data
Apr. 16, 2012 (DE) 10 2012 007 424.7
Dec. 20, 2012 (DE) 10 2012 024 899.7

(51) Int. Cl. C09J 7/02

(52) U.S. Cl. CPC C09J 7/0232
USPC 428/41.7

(57) ABSTRACT

The invention relates to a protective film for applying to a display with a display film and a film protective layer as well as a set for applying a protective film to a display, in particular with a protective film according to the invention.

The invention relates to a protective film for applying to a display with a display film and a film protective layer, and a set for applying a protective film to a display.

Numerous protective films of this kind are known from the state of the art. There is, however, a problem when initially detaching the film protective layer and also when applying the display film without leaving any bubbles.

It is the requirement of the present invention to improve such protective films known from the state of the art.

This requirement is met according to a first aspect of the invention in that the film protective layer comprises a pulling-off aid in the form of a strap. In this way the film protective layer and the display film are easier to separate since it is easier to grasp the strap. The film protective layer protects the side of the display film which is applied to the display. The display film may comprise a second film protective layer on the side facing away from the display film in the applied state.

Advantageously the strap is a tear-resistant film strip. By making the strap out of a film material joint processing is possible. The high tear-resistance of the film material prevents the strap from being torn off.

Preferably the strap comprises a circular opening for attaching a pulling-off aid. The pulling-off aid may, for example, be a thread. This can be pulled through the hole, doubled up along its length and fastened by gluing or knotting. Alternatively the pulling-off aid may be a plastic part which essentially is rod-shaped or spoon-shaped and which may comprise a head part, a centre part and a grip part. A head part would preferably be configured such that it positively engages in the opening of the strap. Preferably the opening is circular, but other opening shapes are feasible such as square, rectangular or oval shapes, or the opening may be shaped as a slot. The circular opening is advantageous since this allows the pulling-off aid to be anchored in the strap so as to be rotatable.

Furthermore it is advantageous if the strap is shaped as a trapeze. The strap may, for example, be formed in one piece with the film protective layer or it may be glued to the same. Compared with a possible rectangular shape, for example, the trapeze shape has the advantage of saving on material in the upper region of the trapeze. If the strap is glued on, the trapeze shape, during gluing on the wider side of the trapeze, has the advantage that despite material savings there remains a large adhesive surface.

Further preferably, the strap is attached centrally to the film protective layer. In this way the film can be detached and applied uniformly in parallel with the outer edge. But it is also feasible for the strap to be attached at one of the corners so that the protective film can be pulled off partially obliquely starting from this edge.

It is advantageous if the strap has a length between 2 and 8 centimetres, preferably between 2 and 5 centimetres. If the strap is within this magnitude it is possible to produce the film and the strap mechanically.

Alternatively it is preferable if the strap is longer than the width of the film at the point of attachment of the strap. In this way it is possible to pull directly on the strap itself while pulling off the film protective layer.

An approximately 0.5 cm to 3 cm wide strip of the film protective layer may be folded over, and the exposed display film may be secured with a covering tape. Preferably the covering tape extends beyond the edge on one side. The strap may be fastened to the folded over part of the film protective layer.

A second aspect of the invention relates to a set for applying a protective film to a display, wherein the set comprises a protective film according to the invention. Apart from the protective film the set may include further components which facilitate applying the protective film or simplify its sale. This may be in the form of packaging or instructions for use, for example.

It is advantageous if a set comprises a pulling-off aid. This may be, in particular, the rod-shaped or spoon-shaped device already described.

Advantageously the pulling-off aid is longer than the width of the film at the point of fastening. This allows to grasp the pulling-off aid easily while pulling off the film protective layer, since it protrudes from under the display film.

A further advantage consists in that the set comprises four rubber patches. These may be fastened at the corners of the underside of the electronic device, to the display of which the protective film shall be applied. In this way the latter is insulated against static charges during application of the film in that it is separated from the base, such as the conducting surface of a table, for example.

A further advantage consists in that the set comprises an anti-static squeegee. This may be used to remove even the smallest of dust particles.

Further it is advantageous if the set comprises an attachment squeegee. Advantageously both squeegees have a concave shape. It is especially advantageous if one corner has an angle of 90°, whilst another corner is rounded off. The rectangular corner allows the edge regions to be easily pressed down, whereas the rounded-off corner makes it easier to squeeze out bubbles between the display and the protective film. Preferably the squeegees have a structure in the upper region, which is for example in the shape of one or two ledges and can serve as a handle. The size of the squeegees may be adapted to suit the size of the display. It is advantageous if the anti-static and attachment squeegees are coloured differently in order to make it easy for the user to distinguish between them.

A further advantage is if the set comprises a micro-fibre cloth. This can be used to clean the display in a preceding step, prior to applying the film.

Further, it is advantageous if the set comprises gloves so that contamination from the hands of the user can be excluded.

The invention will now be described in detail by way of exemplary embodiments with reference to the figures,

in which:

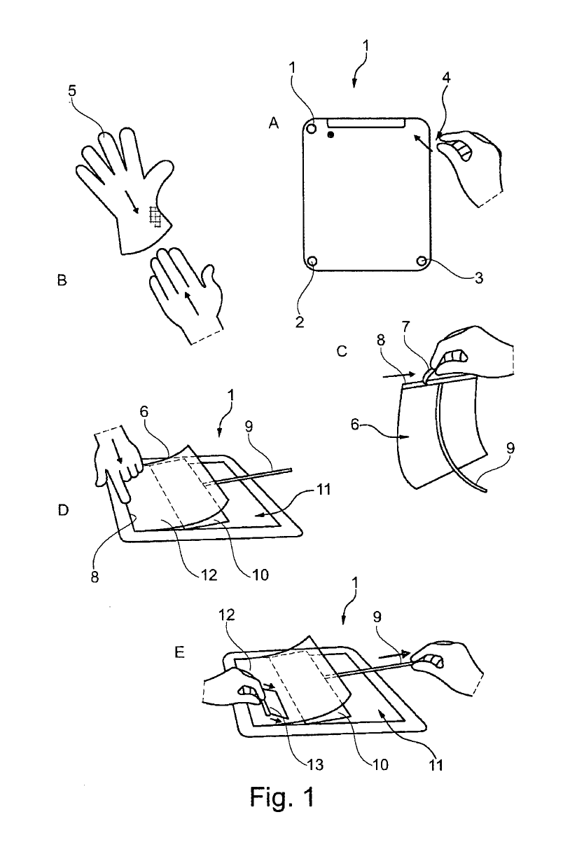

FIG. 1 shows the individual steps A to E for applying a protective film to a display,

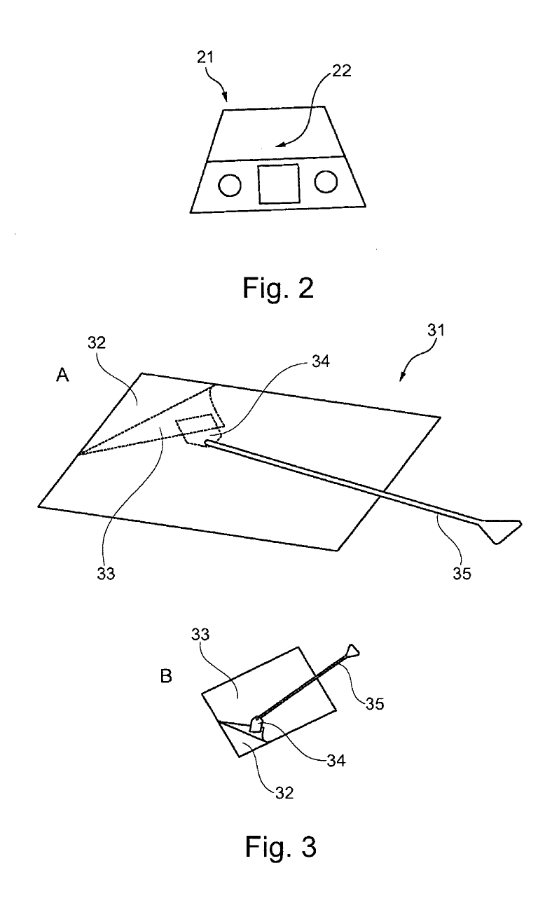

FIG. 2 shows a schematic illustration of a strap and

FIG. 3 shows a schematic illustration of a protective film with a pulling-off aid, with (A) showing a top view and (B) showing an underside view.

In a first step (FIG. 1A), in a technical device 1 comprising a display (not visible since it is on the top side), four adhesive feet 1, 2, 3, 4 have been placed at the corners of the underside.

In a next step (FIG. 1B) gloves such as glove 5 should be pulled on.

In a further step (FIG. 10) an upper region of the protective film 6 is initially exposed by removing a film strip 7 from the film protective layer 10. The film is placed onto the display 11 so as to achieve an exact fit. Then the film is fixed to the device 1 by means of the region 8 of display film 12 exposed by the film strip. Thereupon the film protective layer 10 is pulled off by means of a strap functioning as a pulling-off aid. Meanwhile the display film 12 remaining on the display may be pressed down using a squeegee 13.

Prior to application the display 11 may be cleaned with a micro-fibre cloth, and any remaining fluff or fibres from the micro-fibre cloth may be permanently removed with an anti-static squeegee.

Fastening of the pulling-off aid may be effected by means of a strap 21 such as shown in FIG. 2. This is trapeze-shaped and is glued onto the film in the lower wider region. It comprises a circular opening 22 through which, for example, a ribbon may be threaded, or which may serve to positively engage a pulling-off aid.

A protective film with such a pulling-off aid is shown in FIG. 3. The protective film 31 comprises a display film 32 and a film protective layer 33. A strap 34 is fastened to the film protective layer 33. The strap may serve as an engagement means for the pulling-off aid 35. The pulling-off aid may be used to permanently remove the protective film 33.

The recommended procedure is as follows. Adhesive feet are again attached to the corners of the underside of the device. In a next step the display is thoroughly cleaned using a micro-fibre cloth. In a further step an anti-static squeegee is guided across the display without applying pressure, in order to remove even the smallest dust particles. In a further step a region of the film protective layer is separated from the display film by rolling it off over the thumb. This region should be between approx. 1 cm and 1.5 cm. In a next step the pulling-off aid is inserted into the pre-punched hole of the label. Then the protective film can be bent over in the pulled-off region. Finally the film can be completely deposited on the display without being fixed to it. The film can be aligned, wherein the recesses for loudspeaker and camera, if applicable, may serve as an orientation guide.

The exposed region of the display film is then fixed to the display by means of light finger pressure. The film is held in this region and the protective film is slowly and evenly pulled-off by means of the pulling-off aid protruding in downward direction from below the display film. Finally air bubbles may be squeezed out using a second attachment squeegee. A further protective film possibly applied to the other side of the display film can then be completely removed. Finally the adhesive feet need removing again from the rear of the device.

1. A protective film for applying to a display with a display film and a film protective layer, wherein the film protective layer comprises a pulling-off aid in the form of a strap.

2. The protective film according to claim 1, wherein the strap is a tear-resistant film strip.

3. The protective film according to claim 1, wherein the strap comprises a circular opening for attaching a pulling-off aid.

4. The protective film according to claim 1, wherein the strap is trapeze-shaped.

5. The protective film according to claim 1, wherein the strap is attached centrally to the film protective layer.

6. The protective film according to claim 1, wherein the strap has a length of between 2 and 8 cm, preferably between 2 and 5 cm.

7. The protective film according to claim 1, wherein the strap is longer than the width of the film at the point at which the strap is attached.

8. A set for applying a protective film to a display, wherein it comprises a protective film according to claim 1.

9. The set according to claim 8, wherein it comprises a pulling-off aid.

10. The set according to claim 9, wherein the pulling-off aid is longer than the width of the film at the point at which the pulling-off aid is attached.

11. The set according to claim 8, wherein it comprises four rubber patches.

12. The set according to claim 8, wherein it comprises an anti-static squeegee.

13. The set according to claim 8, wherein it comprises an attachment squeegee.

14. The set according to claim 8, wherein it comprises a micro-fiber cloth.

15. The set according to claim 8, wherein it comprises gloves.
